(19) United States
(12) Patent Application Publication
(10) Pub. No.: US 2015/0124388 A1
(43) Pub. Date: May 7, 2015

(54) ELECTRONIC DEVICE

(71) Applicants: INVENTEC CORPORATION, Taipei (TW); Inventec (Pudong) Technology Corporation, Shanghai (CN)

(72) Inventors: I-Wei SHEN, Taipei (TW); Chien-Shun HUANG, Taipei (TW)

(73) Assignees: Inventec (Pudong) Technology Corporation, Taipei (TW); INVENTEC CORPORATION, Taipei (TW)

(21) Appl. No.: 14/227,928

(22) Filed: Mar. 27, 2014

(30) Foreign Application Priority Data
Nov. 6, 2013 (CN) 2013105456919

(51) Int. Cl. G06F 1/16

(52) U.S. Cl. CPC G06F 1/1675; G06F 1/1637
USPC 361/679.09; 361/679.27

(57) ABSTRACT

An electronic device includes a main body, two transmitting members, a display module and two drivers. The main body has a first side and a second side opposite to each other. The two transmitting members are movably located on the first side and the second side respectively. The display module has two pivoting portions connected to the two transmitting members respectively. The two drivers are disposed on the main body and drive the two transmitting members to make the display module move relative to the main body.

### CROSS-REFERENCE TO RELATED APPLICATIONS

This non-provisional application claims priority under 35 U.S.C. §119(a) on Patent Application No(s). 2013105456919 filed in China, P.R.C. on Nov. 6, 2013, the entire contents of which are hereby incorporated by reference.

### BACKGROUND OF THE INVENTION

1. Technical Field of the Invention

The disclosure relates to an electronic device, more particularly to an electronic device with a display module capable of moving relative to a main body.

2. Description of the Related Art

Generally speaking, a notebook comprises a display module and a main body. In today's notebooks, however, the display module is only pivoted on the main body and cannot move relative to the main body. Hence, users rotate the display module about the pivot so that the display module pivots relative to the main body for the optimal viewing position.

The touch screen has become popular since the operating system Windows® 8 launched by Microsoft®. Since the display module is not capable of moving relative to the main body, users may accidentally touch the keyboard while operating the touch screen. As a result, it is uncomfortable for users to operate the notebook with the touch screen

### SUMMARY OF THE INVENTION

An electronic device comprises a main body, two transmitting members, a display module and two drivers. The main body has a first side and a second side opposite to each other. The two transmitting members are movably located on the first side and the second side respectively. The display module has two pivoting portions connected to the two transmitting members respectively. The two drivers are disposed on the main body and drive the two transmitting members to make the display module move relative to the main body.

### BRIEF DESCRIPTION OF THE DRAWINGS

The present disclosure will become more fully understood from the detailed description and the drawings given herein below for illustration only, and thus does not limit the present disclosure, wherein:

FIG. 1 is a perspective view of an electronic device according to an embodiment of the disclosure;

FIG. 2 is an exploded view of an electronic device according to the embodiment of the disclosure;

FIG. 3 is a perspective view of an electronic device at a stationary position according to the embodiment of the disclosure; and

FIG. 4 is a perspective view of an electronic device at a use position according to the embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

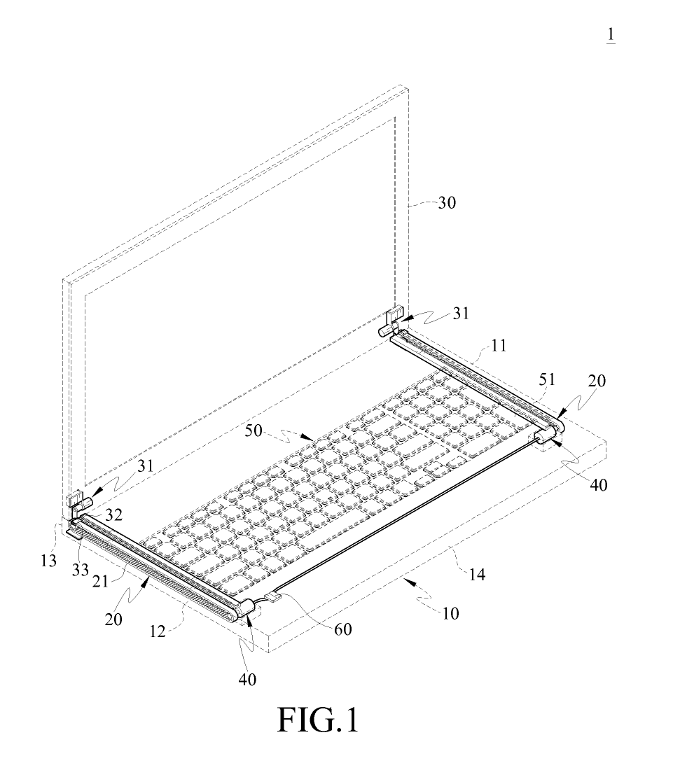

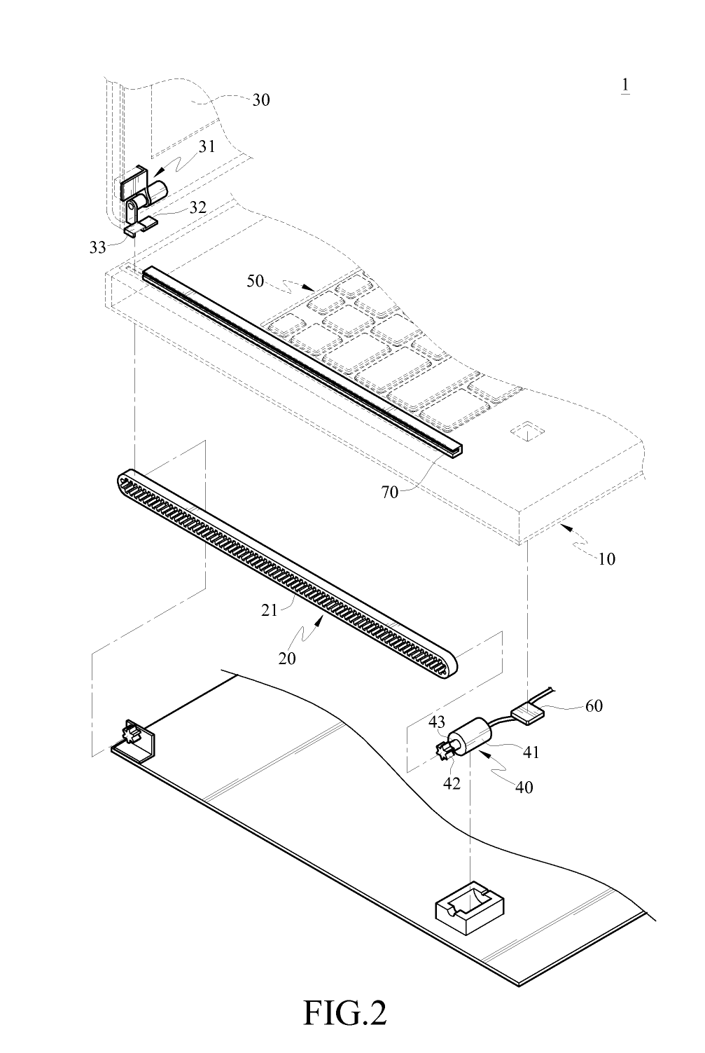

FIG. 1 is a perspective view of an electronic device according to an embodiment of the disclosure; FIG. 2 is an exploded view of an electronic device according to the embodiment of the disclosure. As seen in FIG. 1 and FIG. 2, the electronic device 1 of this embodiment comprises a main body 10, two transmitting members 20, a display module 30, two drivers 40, a keyboard module 50, a control key 60 and two guiding rails 70.

In this embodiment, the electronic device 1 is a laptop with a touch panel, but it is not limited thereto. In other embodiments, the electronic device 1 may be a notebook with a normal screen or any other electronic device with a screen.

The main body 10 has a first side 11 and a second side 12 opposite to each other, as well as a third side 13 and a fourth side 14 opposite to each other. Additionally, the third side 13 is between the first side 11 and the second side 12. The fourth side 14 is between the first side 11 and the second side 12.

In this embodiment, the number of the transmitting members is two. The two transmitting members 20 are movably disposed on the first side 11 and the second side 12 respectively, and the inside of the transmitting member 20 has a teeth portion 21. In this embodiment, the transmitting member 20 is a track, but it is not limited thereto. In other embodiments, the transmitting member 20 may be a belt or a chain.

The drivers 40 are movably disposed on the main body 10. In this embodiment, the number of the drivers 40 is two. The driver 40 comprises a motor 41 and a gear 42. The gear 42 is located on a shaft 43 of the motor 41. Furthermore, the transmitting member 20 surrounds the gear 42 of the driver 40 and the gear 42 engages with the teeth portion 21 of the transmitting member 20. In this embodiment, the motor 41 is a stepper motor. In other embodiments, however, the motor may be a pulse motor.

The keyboard module 50 is disposed on the main body 10, for receiving the input signal and for transmitting the signal to the main body 10. The two transmitting members 20 are located on the opposite sides of the keyboard module 50, respectively. In this embodiment, the keyboard module 50 further comprises an operating key 51 electrically connected to the driver 40, but the disclosure is not limited thereto. In other embodiments, the keyboard module 50 does not have the operating key 51.

In this embodiment, the electronic device 1 further comprises a control key 60. The control key 60 is disposed on the main body 10 and is electrically connected to the driver 40.

In this embodiment, the electronic device 1 further comprises two guiding rails 70. In this embodiment, the two guiding rails 70 are disposed on the first side 11 and the second side 12 respectively, and the guiding rail 70 and the transmitting member 20 are arranged next to each other.

The electronic device 1 further comprises a display module 30. The display module 30 has a pivoting portion 31. The pivoting portion 31 has a first extending member 32 and a second extending member 33. The first extending member 32 matches the guiding rail 70 and the second extending member 33 is connected to the transmitting member 20.

The connection method of the display module 30 and the main body 10 is illustrated as follows.

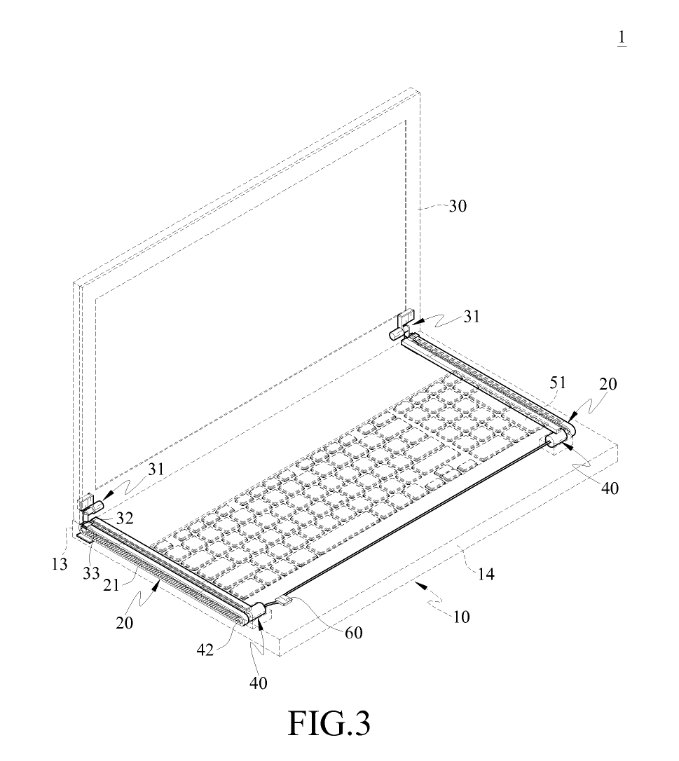

FIG. 3 is a perspective view of an electronic device at a stationary position according to the embodiment of the disclosure. As seen in FIG. 3, the display module 30 has a pivoting portion 31. In this embodiment, when the electronic device 10 is at a stationary position, the pivoting portion 31 of the display module 30 is on the third side 13 of the main body 10.

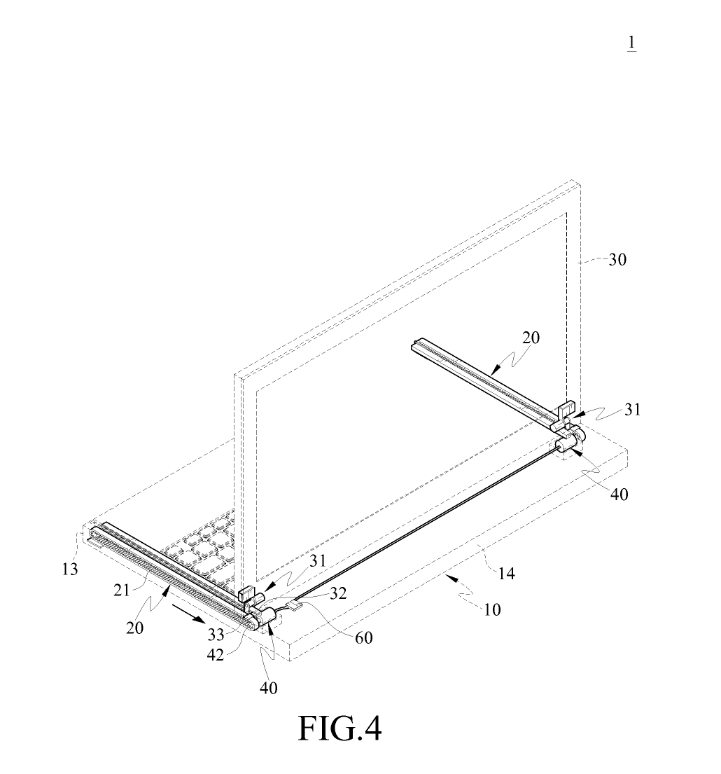

The method to start the use position of the electronic device 1 is illustrated as follows. FIG. 4 is a perspective view of an electronic device at a use position according to the embodiment of the disclosure. As shown in FIG. 4, after the user presses the control key 60 of the main body 10, the driver 40, electrically connected to the control key 60, receive the command and drive the transmitting member 20 to make the display module 30 move relative to the main body 10. Specifically, the direction of movement of the display module 30 is from the third side 13 to the fourth side 14 or from the fourth side 14 to the third side 13.

In detail, when the user presses the control key 60 disposed on the main body, since the control key 60 is electrically connected to the driver 40, the driver 40 is driven by the external command. Then, the motor 41 drives the shaft 43 to rotate, thereby making the gear 42 rotates accordingly. Subsequently, due to the fact that the transmitting member 20 surrounds the gear 42 of the driver 40 and the gear 42 engages with the teeth portion 21 of the transmitting member 20, the rotation of the gear 42 drives the driver 20. Thereby, the pivoting portion 31 of the transmitting member 20 moves accordingly, and this enables the display module 30 to move relative to the main body 10. In this embodiment, the motor 41 is a stepper motor, but it is not limited thereto. The control key 69 sends a pulse signal of the demand of operation required, and the driver 40 provides a stable power and control signal to stepper motor 41 for driving it. As a result, the stepper motor 41 is capable of driving the gear 42 to take the display module 30 to the desired position accurately.

For instance, when the control key 60 receives a command that the display module 30 needs to move from the third side 13 to the fourth side 14, the motor 41 of the driver 40 drives the shaft 43 to make the gear 42 rotate clockwise. The teeth portion 21 of the transmitting member 20, therefore, is driven to move from the third side 13 to the fourth side 14. In contrast, when the control key 60 receives a command that the display module 30 needs to move from the fourth side 14 to the third side 13, the motor 41 of the driver 40 drives the shaft 43 to make the gear 42 rotate counterclockwise. The teeth portion 21 of the transmitting member 20, thus, is driven to move from the fourth side 14 to the third side 13.

When the user presses the control key 60 of the main body 10, the driver 40 drives the motor 41 based on the pulse signal sent by the control key 60, so that the shaft 43 makes the gear 42 rotate clockwise or counterclockwise. Thereby, the transmitting member 20 engaged with the gear 42 can make the display module 30 move relative to the main body 10 depending on the rotational direction of the gear 42. Hence, the users can adjust the display module 30 to a place suitable for them to operate or to view, and can avoid the situation of touching the keyboard module 50 of the main body 10 accidentally.

To sum up, in the electronic device illustrated in the embodiments mentioned above, the first extending member and the second extending member are both connected to the guiding rail and the transmitting member. Thus, when the driver receive the external signal to make the motor drive the gear to rotate, the transmitting member surrounding the gear drive the display module. Thereby, the pivoting portion of the display module can slide in the guiding rail so that the display module is capable of moving relative to the main body. The users can adjust the display module to a place suitable for them to operate or to view, and can avoid the situation of touching the keyboard module of the main body accidentally.

What is claimed is:

1. An electronic device comprising:
a main body having a first side and a second side opposite to each other;
two transmitting members movably located on the first side and the second side respectively;
a display module having two pivoting portions connected to the two transmitting members respectively; and
two drivers disposed on the main body, the two drivers driving the two transmitting members to make the display module move relative to the main body.

2. The electronic device according to claim 1, further comprising a keyboard module disposed on the main body, the two transmitting members are located on the opposite two sides of the keyboard module respectively.

3. The electronic device according to claim 2, wherein the keyboard module comprises at least one operating key, and the at least one operating key is electrically connected to the two drivers.

4. The electronic device according to claim 1, wherein the main body further has a third side and a fourth side opposite to each other, the third side and the fourth side are respectively located between the first side and the second side, and the pivot portion is adapted for moving from the third side to the fourth side or moving from the fourth side to the third side.

5. The electronic device according to claim 1, further comprising a control key located on the main body and electrically connected to the two drivers.

6. The electronic device according to claim 1, wherein each of the two transmitting members is a track and has a teeth portion inside, wherein each of the two drivers comprises a motor and a gear, the gear is located on a shaft of the motor, and the gear engages with the teeth portion.

7. The electronic device according to claim 6, wherein the two transmitting members respectively surround the two gears of the two drivers.

8. The electronic device according to claim 1, further comprising two guiding rails, wherein the two guiding rails are disposed on the main body, and the two pivoting portions of the display module are respectively located on the two guiding rails and are configured for sliding on the two guiding rails.

9. The electronic device according to claim 8, wherein the two pivoting portions each has a first extending member and a second extending member, the first extending member matches the guiding rail and the second extending member is connected to the transmitting member.

10. The electronic device according to claim 9, wherein the guiding rail and the transmitting member are arranged next to each other.
